(19) United States
(12) Patent Application Publication
(10) Pub. No.: US 2014/0217688 A1
(43) Pub. Date: Aug. 7, 2014

(54) TRASH/RECYCLING CART

(71) Applicant: Cascade Engineering, Inc., Grand Rapids, MI (US)

(72) Inventors: Dean T. Miller, Wyoming, MI (US); Linda R. Umlor, Grandville, MI (US)

(73) Assignee: Cascade Engineering, Inc., Grand Rapids, MI (US)

(21) Appl. No.: 14/093,556

(22) Filed: Dec. 2, 2013

Related U.S. Application Data
(60) Provisional application No. 61/760,735, filed on Feb. 5, 2013.

(51) Int. Cl. B62B 1/16

(52) U.S. Cl. CPC B62B 1/16
USPC 280/47.26; 280/79.2

(57) ABSTRACT

The specification discloses a high-profile, low-volume trash/recycling cart that is compatible with existing pick-up equipment and includes a reduced volume. The cart includes a container and a pedestal supporting the container. The pedestal increases the overall height of the cart to be conveniently handled by existing automated handling equipment. The container can be separated from the pedestal and used as a standalone refuse container. Additionally, wheels may be included on the container to provide a rolling standalone container. Alternatively or additionally, when the pedestal is separated from the container, the pedestal can be fitted with a handle to provide a utility cart.

### BACKGROUND OF THE INVENTION

The present invention relates to trash/recycling carts, and more particularly to multi-piece carts.

Separating recyclable and organic waste from other types of residential trash is a valuable practice for reducing the amount of material deposited into landfills, and to divert it for sustainable uses. It is often advantageous to collect smaller quantities of these materials at pick-up, due to high material density or other factors. Restricting the amount of material collected per pick-up is accomplished through the use of a smaller volume cart.

Current practice teaches that small volume carts are desirable for the collection of various types of trash and recyclable waste, and that these carts have features that are compatible with existing automated & semi-automated pick-up equipment. However, current offerings require manual handing to locate and align the cart to existing equipment, or adjustment of the equipment to accommodate the smaller cart. When relatively small carts have been used for low volume waste or refuse they have generally not been large enough in one or more dimensions to be used with standard collection systems. Usually, small volume carts are required to be raised, or somehow increased in height, to meet standardized heights established by the solid waste industry and ANSI (American National Standards Institute).

Several carts are known to have reduced volumes for trash, recycling and organic waste collection. Some of these carts are smaller than conventional carts, and do not meet all of the specifications for collection with automated handling equipment. Their low height makes it more difficult for the user to comfortably reach the handles and maneuver the cart. Other carts have been fitted with inserts to limit the volume of material that may be placed in the cart. The inserts, however, increase material cost and provide opportunity for the user to remove the insert and overfill the cart with a material that was intended to be limited in volume.

### SUMMARY OF THE INVENTION

The present invention provides a multi-piece refuse cart having a container and a pedestal supporting the container. The pedestal raises the overall height of the cart for convenient pickup and emptying by standard waste industry automated pickup equipment. The cart holds a reduced volume of waste material at a height where existing automated handling equipment may be used to pick-up and empty the cart. Furthermore, the pedestal increases the height of the handle so that it is easily reachable, and allows comfortable maneuvering of the cart.

In the disclosed embodiment, the container and pedestal are snap-fitted together by at least a pair of snap fit elements. Alternatively, the container and pedestal are connected with conventional fasteners.

In the disclosed embodiment, the pedestal includes wheels. Optionally, the container of the cart may include wheel supports in the event the user desires to use the container alone as a rolling, standalone cart.

In an alternative embodiment, when separated from the upper refuse container, the pedestal base includes a handle on a back wall and functions as a utility cart.

The current invention provides a cart that limits the volume of material contained in it and minimizes the materials used in its construction. Further, the cart described herein prevents tampering by the user to create a space that would allow the cart to be overfilled with a material that is intended to be collected in a limited volume.

### BRIEF DESCRIPTION OF THE DRAWINGS

FIG. 1 is a perspective view of the cart in a closed position.

FIG. 2 is a perspective view of the cart in an open position.

FIG. 3 is a perspective view of the underside of the cart.

FIG. 4 is a top perspective view of the container portion of the cart.

FIG. 5 is a bottom perspective view of the container portion of the cart with axle support.

FIG. 6 is a top perspective view of the pedestal portion of the cart.

FIG. 7 is a bottom perspective view of the pedestal portion of the cart.

FIG. 8A is a detailed view of the protrusion/curved notch snap fittings in an open position.

FIG. 8B is a detailed view of the protrusion/curved notch snap fitting in a closed position.

FIG. 9A is a detailed view of the ramp/square notch snap fitting in an open position.

FIG. 9B is a detailed view of the ramp/square notch snap fitting in a closed position.

FIG. 10A is a detailed view of the interference fit components in an open position.

FIG. 10B is a detailed view of the interference fit components in a closed position.

FIG. 11 is a detailed view of attachment examples.

FIG. 12 is a top perspective view of a container with a horizontal rim.

FIG. 13 is a bottom perspective view of the container without axle support elements.

FIG. 14A is a front perspective view of the container as a cart without the pedestal.

FIG. 14B is a rear perspective view of the container as a cart without the pedestal.

FIG. 15A is a perspective view of the pedestal as a utility cart.

FIG. 15B is a top perspective view of the pedestal as a utility cart.

FIG. 15 C is a rear perspective view of the pedestal as a utility cart.

FIG. 16 is a detailed view of the underside of the rim of the container.

### DESCRIPTION OF THE CURRENT EMBODIMENTS

The multi-piece waste cart provides a high-profile, low-volume waste container compatible with standardized refuse collection systems and system components. The cart assembly consists of an upper container with a defined interior volume attached to a lower base that positions the upper container to be compliant with standards for automated and semi-automated handling equipment.

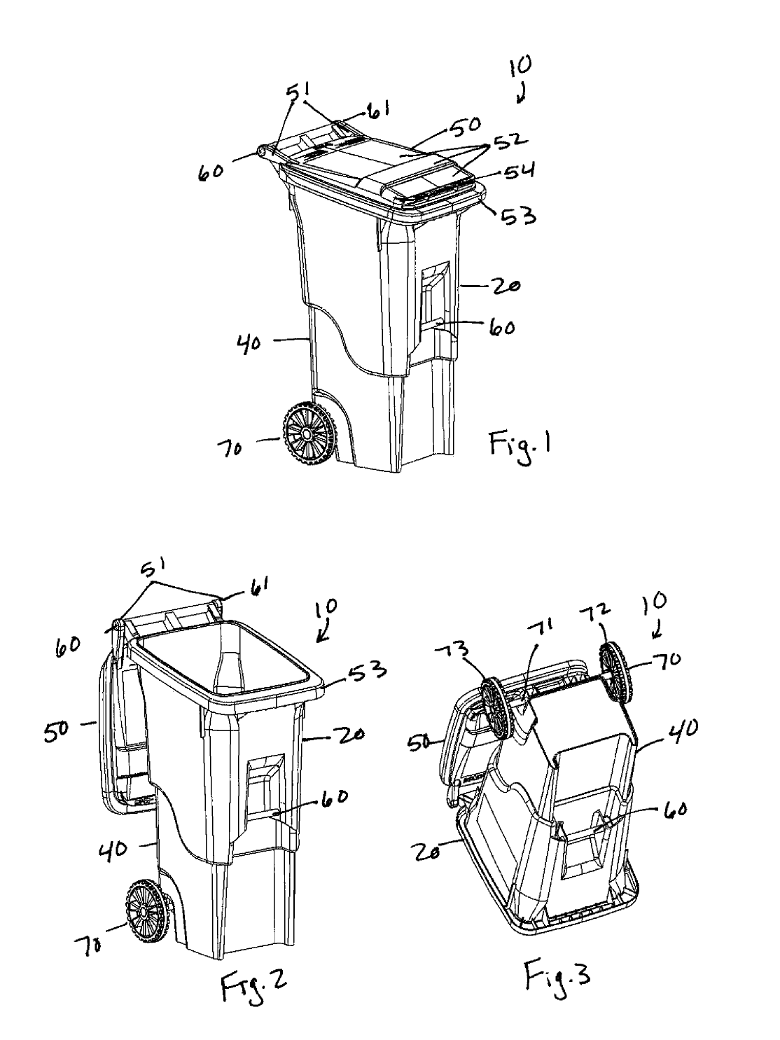

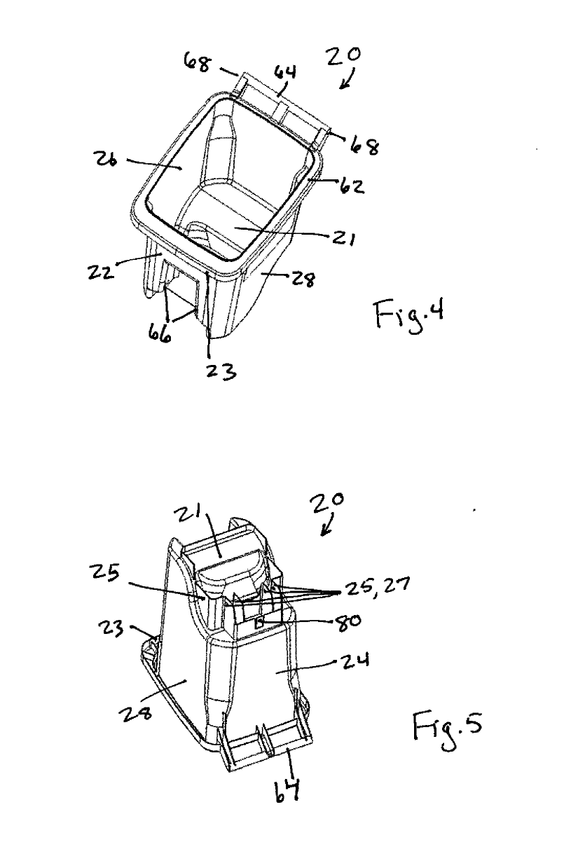

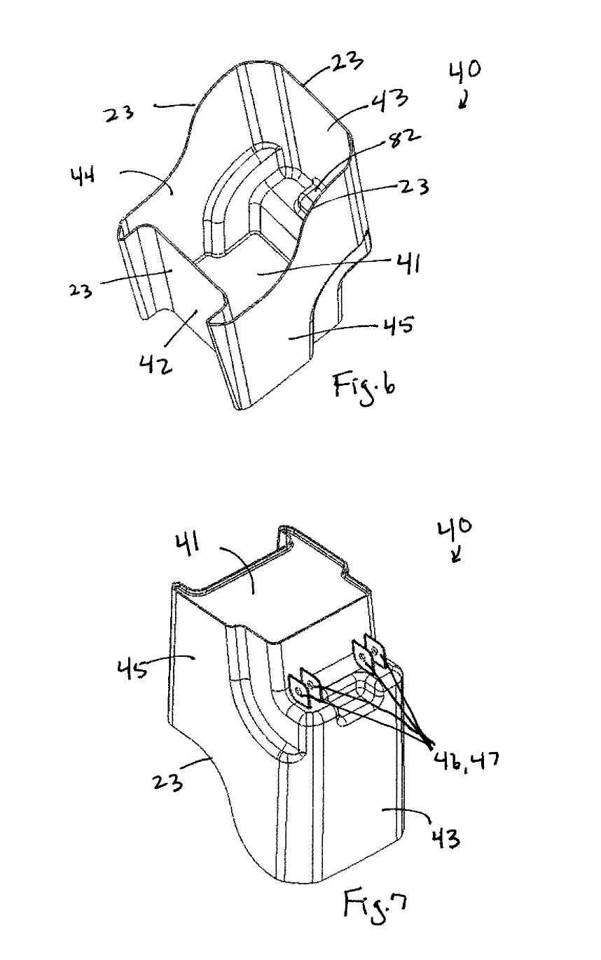

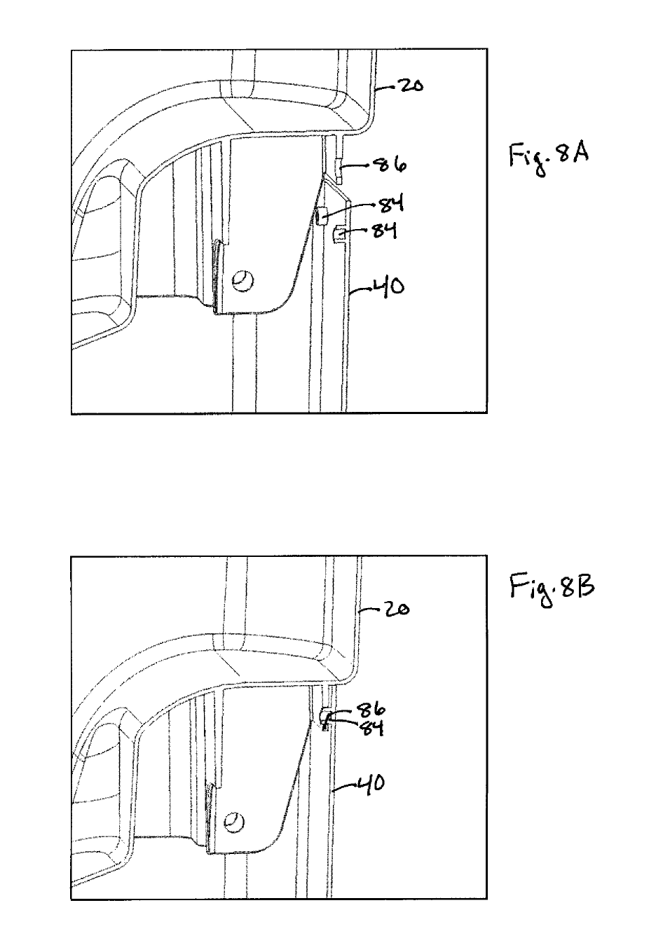

A cart in accordance with the present invention is shown in FIGS. 1-2 and is generally designated 10. The cart 10 has an upper container 20 and a separable lower pedestal 40. The upper container 20 includes a lid 50 that is attached to the upper container 20 by hinges 51 and hinge pins 60, 61. As seen in the illustrated embodiment, the lid 50 includes convex surfaces 52 and can be lifted open by a handle 54. The upper container 20 includes an edge flange with overhang side walls 53 and a grab bar 60. The lower pedestal 40 includes a wheel assembly 70 to facilitate movement of the cart 10 from one location to another. As shown in FIG. 3, the wheel assembly 70 consists of an axle 71 and two wheels 72 and 73.

FIGS. 4 and 5 provide additional details of the upper container 20. The container 20 includes a floor 21, front 22, back 24 and side walls 26, 28. An angled rim 62 is at the open end of the upper container 20. The angled rim 62 has an attached handle 64 with integrated hinge pin attachments 68 for receiving hinge pins 60, 61. On the front side 22 the container includes a grab bar attachment 66 and lift pocket 23. The container 20 includes a descending wall 25 with axle openings 27 for supporting the axle 71 if it is desired that the container 20 be used separately from the pedestal 40.

FIGS. 6 and 7 provide details of the pedestal 40 portion of the container 10. The pedestal 40 includes a floor 41, front 42, back 43, and side walls 44 and 45 that include attachment features that align with the attachment features of the container 20 (discussed in detail below) of the cart 10. The pedestal 30 includes a descending wall 46 with axle openings 47 for supporting the axle 71.

Directional terms such as “vertical,” “horizontal,” “top,” “bottom,” “upper,” “lower,” “inside,” “inner,” “inwardly,” “outside,” “outer,” and “outwardly,’ are used to assist in describing the invention based on the orientation of the embodiments shown in the illustrations. The use of directional terms is merely an expedient to facilitate disclosure with reference to the illustrations and should not be interpreted to limit the invention carts of any specific orientation(s).

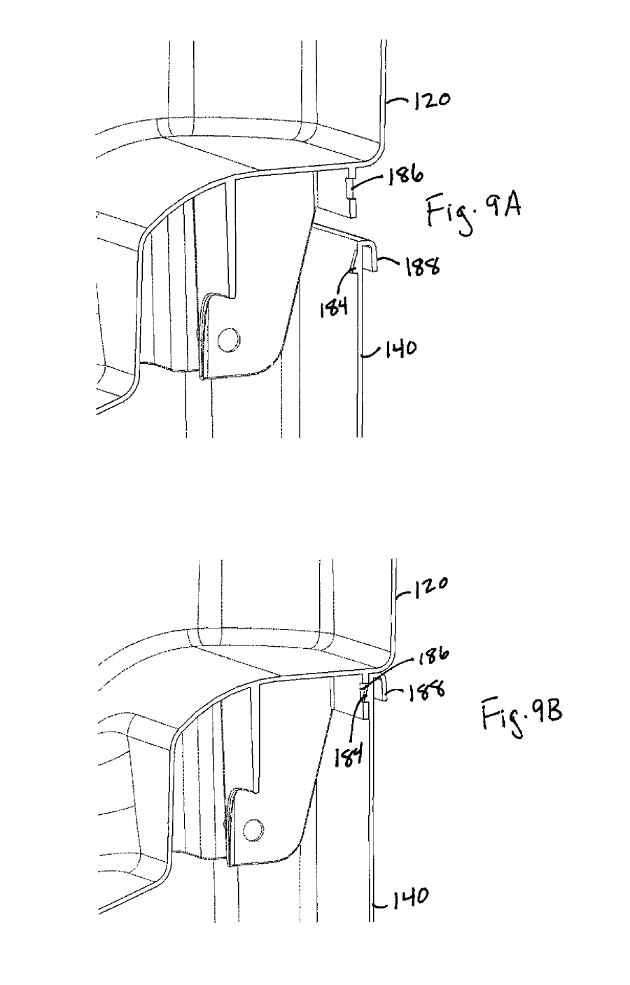

As shown in FIGS. 5-8, the upper container 20 and lower pedestal 40 of the cart 10 can be attached and secured together by attachment ribs 25 attachment features shown generally 80 and 82 in FIGS. 5-6 on the descending floor 21 of the container 20. The attachment features may be a pair or a plurality of opposed interlocking protrusions and openings such as snap fittings. In FIGS. 8A and 8B the snap fittings are shown as protrusions 84 on the pedestal 40 that will align and snap together with a corresponding curved notch 86 on the container 20. As shown in the figures, the protrusions 84 are molded into the inside, top part of the pedestal 40, while the curved notches 86 are cut out areas near the bottom of the container. It should be understood with respect to the protrusions 84 and curved notches 86 of FIGS. 8A and 8B, as well as for other types of fittings and attachments features discussed herein, that the position of the protrusion(s) and notches(s) could be reversed so that the protrusion(s) are on the container 20 and the notches 86 are on the pedestal.

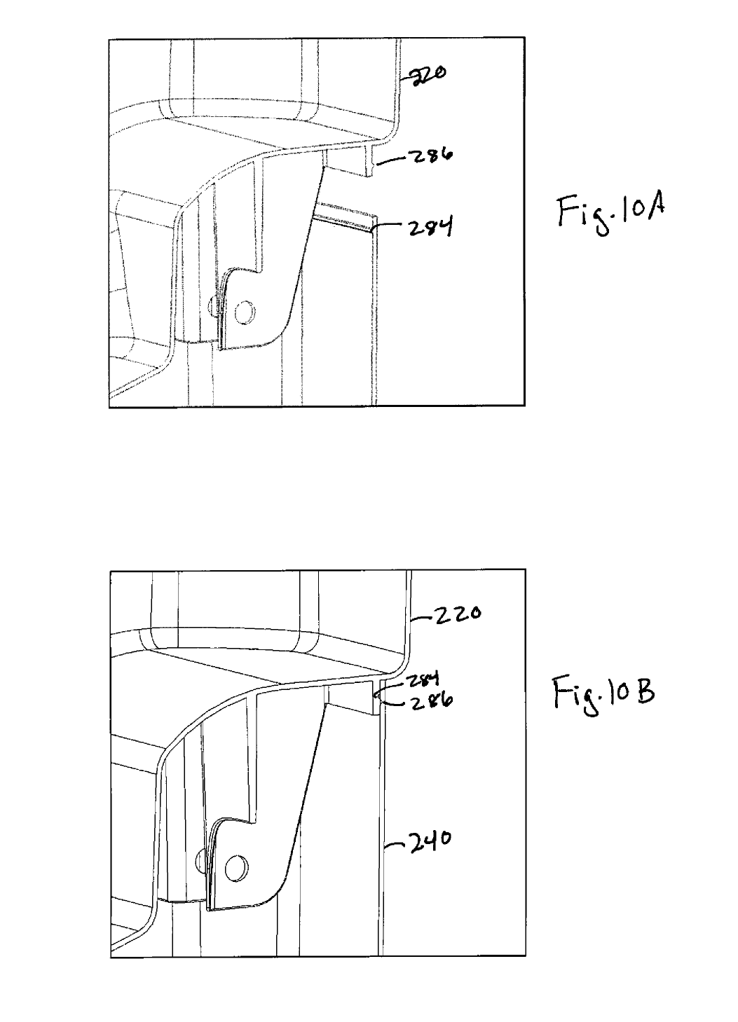

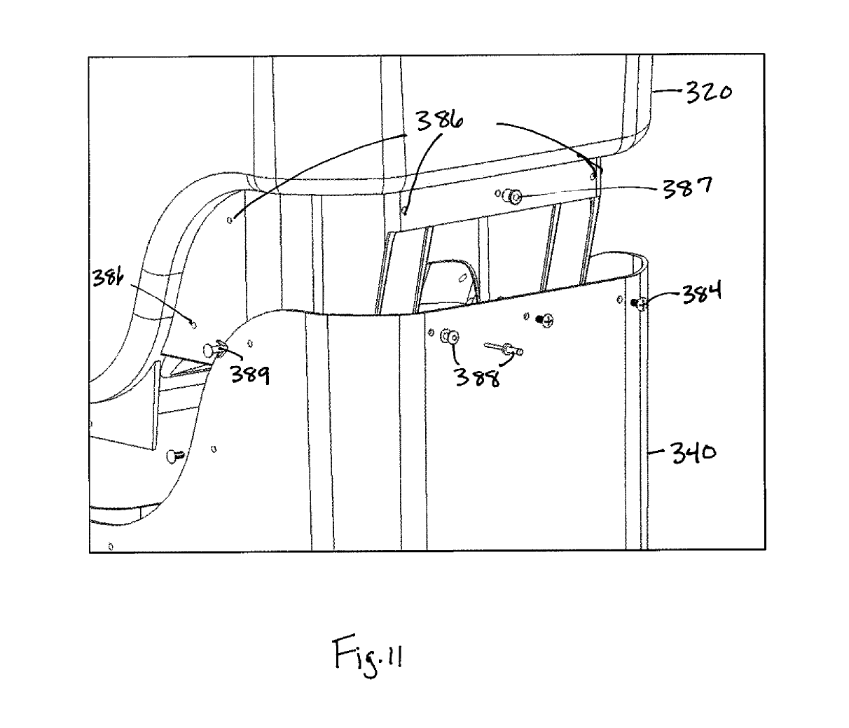

The attachment features may also be pairs or a plurality of pairs of opposed ramps and square notches as shown in FIGS. 9A and 9B. As seen in the Figures, the ramps 184 are molded into the inside top portion of the pedestal 140 and the corresponding square notch 186 is a cut out area on the lower end of the container 120. The embodiment depicted in FIGS. 9A and 9B further includes a return flange rim 188 adjacent to the side walls of on the pedestal 140 to provide additional stiffness and maintain the shape of the pedestal base 140. As shown in FIGS. 10A and 10B, the snap fit between the pedestal 240 and the container 220 can be achieved by including a pair of corresponding bumps, protrusions, landings or ridges 284, 286 in upper portion of the pedestal 240 and lower portion of the container 220.

The container 20, 120, 220 may be secured and guided into position over the pedestal 40, 140, 240 by providing any of the illustrated snap fit features or other fittings known in the art. The meeting of the various fitting elements provides tactile confirmation to the assembler of the cart that the container 20, 120, 220 is securely in place on the pedestal 40, 140, 240. The protrusions 84, 184, curved and square notches 86, 186 as well as the bumps or ridges 284, 286 may be present in a single or in multiple pairs. The number of snap elements may vary and they may be positioned in essentially any desired location on either the container 20, 120, 220 or on the pedestal 40, 140, 240. The characteristics of the snap fit elements, such as the number, location, shape and/or length of the snap elements, may be varied to provide the stiffness desired to maintain a snap-fit between the protrusions 84, 184 and notches 86, 186 for example.

While the figures depict specific shapes of snap fit elements or attachment elements, these features may exist in a variety of shapes and sizes. The steepness of the ramps 184 and corresponding depth of the notches 186 may vary, for example, to control the amount of force desired to snap the ramps 184 and notches 186 together or to undo their connection and separate the container 120 from the pedestal 140.

Other examples of attachment features are shown in FIG. 11. One or more holes 386 may be present in one or both of the container 320 and pedestal 340. The pairs of holes 386 from the pedestal 340 and the container 320 are aligned to accommodate a screw(s) 384 with or without insert(s) 387, rivet(s) 388 or barbed clips, bird-beak clip(s) 389, and Christmas tree fastener(s) 390. The attachment features may include one type of fastener shown in FIG. 11 or a combination of fasteners as shown in the figures or as are commonly known. Further a combination of fasteners and snap fit elements may be used.

Alternate embodiments include differences in the shape of the angled rim 62 of FIGS. 1-5. For example, the embodiments of FIGS. 1-5 depict a cart 10 having a container 20 with an angled rim 62, the rim may be angled differently or may be horizontal. FIG. 12 includes a container 420 with a horizontal rim 462. Attached handle 464 and integrated hinge pin attachments 460 and 461. The lid 50 is connected to container 420 in the same fashion the lid 50 is attached to the container 20 of FIGS. 1-3.

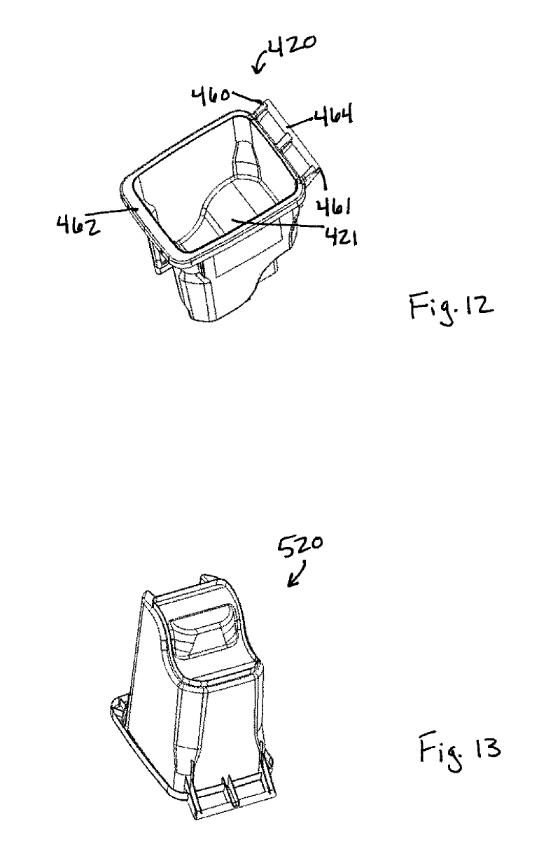

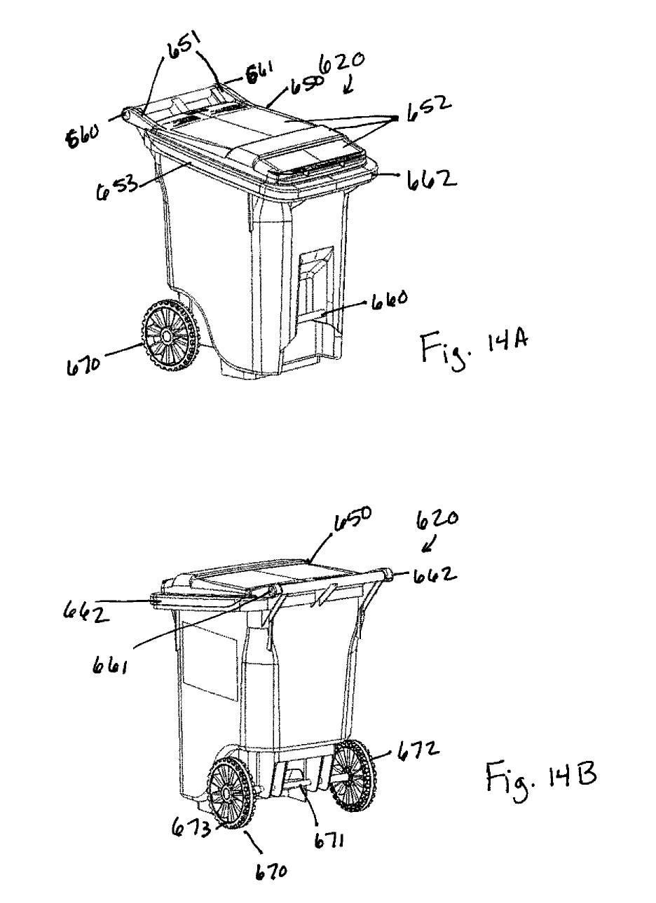

While FIG. 5 includes the descending wall 25 with axle openings 27 for supporting the axle 71 if it is desired that the container 20 be used separately from the pedestal 40 these features may be excluded if desired, the container 20 may alternatively be constructed without these elements. For example, FIG. 13 depicts an embodiment of the container 520 without axle support elements. It should be understood that an angled or a horizontal rim may be used on containers 20, 120, 220, 320, 420, 520 as desired and also that axle attachment elements may be present or not.

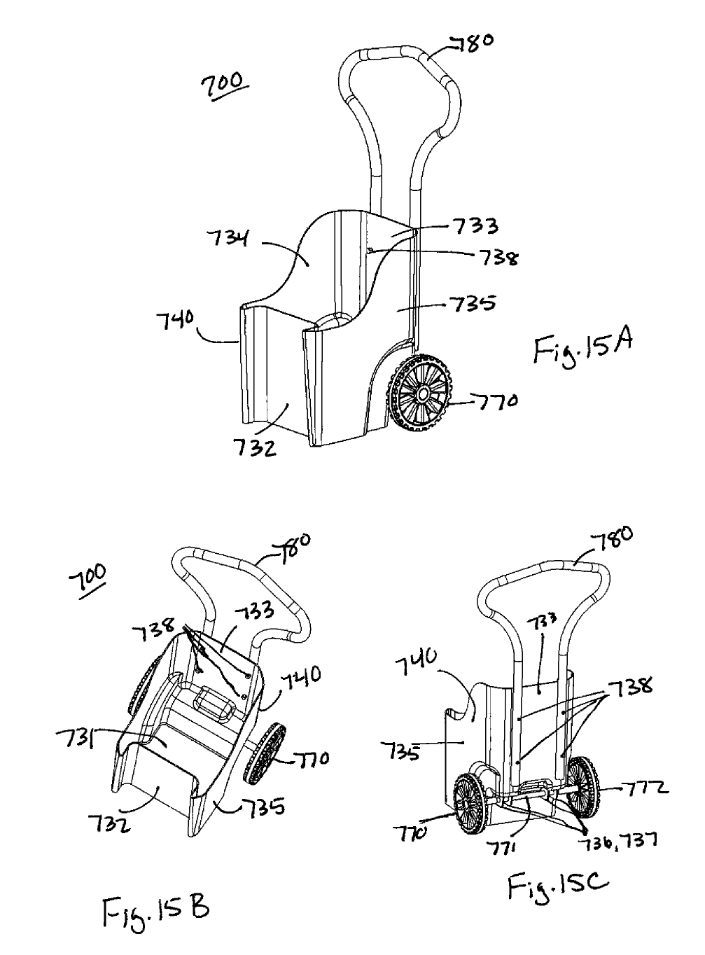

In use, the container 620 of the separable cart 10 can be fitted with wheels 670, as shown in FIG. 14A, and used as a rolling cart separately from the pedestal 40. The container 620 includes a lid 650 that is attached to the upper container 620 by hinges 651 and hinge pins 660, 661. The lid 650 includes convex surfaces 652 and can be lifted open by a handle 654. The container 620 includes an edge flange with overhang side walls 653 and a grab bar 660. The container 620 includes a wheel assembly 670 to facilitate movement of the container 620 from one location to another. As seen in FIG. 14B, the wheel assembly 670 consists of an axle 671 and two wheels 672 and 673. As with the embodiments of FIGS. 1-5 that depict a cart 10 having a container 20 with an angled rim 62, the rim 662 of the embodiment shown in FIG. 14A and 14B may be angled or horizontal.

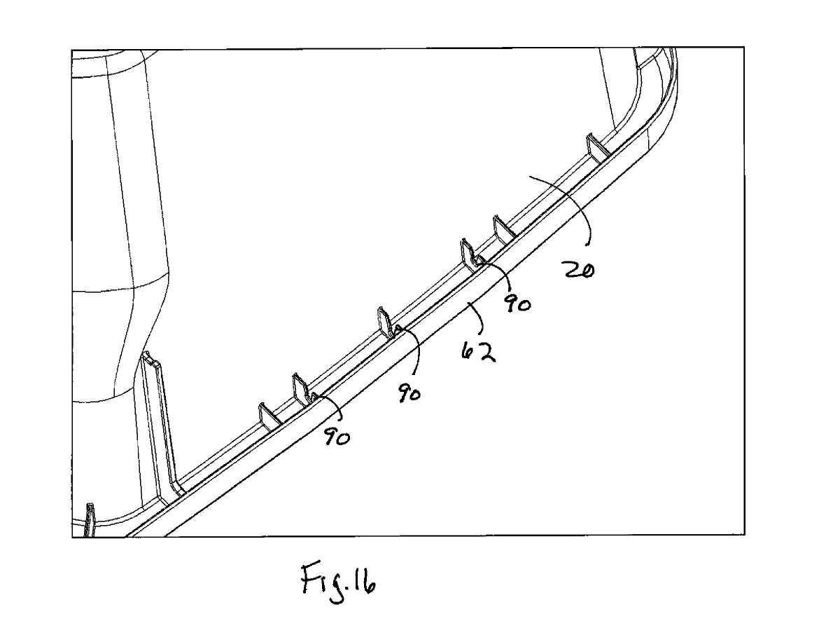

Additionally, the pedestal 40 of FIGS. 1-5 may be configured with a handle for use as a utility cart. The utility cart 700 of FIGS. 15A, 15B and 15C includes the pedestal base 740 with floor 731, front 732, back 733 and side walls 734 and 735. A handle 780 is attached to the utility cart 700 by attachment holes 738. Attachment of the handle 780 to the utility cart 700 can be achieved by use of the fasteners or snap fittings described herein with respect to attaching the container 20 to the pedestal 40 or by other means commonly known in the art. Descending axle mounting walls 736 are molded into the back wall 733 of the pedestal 740 and include axle openings 737 through which an axle 771 of the wheel assembly 770 is accommodated. Wheels 772 and 773 are attached to the axle. The attachment holes 738 for mounting the handle 780 are shown in FIG. 15C as part of the descending wall axle mounting wall 736 on the back wall 733 of the pedestal 740. However, the attachment holes 738 may be placed on the back wall 733 if desired.

As shown in FIG. 9B, the pedestal 140 includes a return flange rim 188 adjacent to the side walls of on the pedestal 140 to provide additional stiffness and maintain the shape of the pedestal 140. Any of the pedestals 40, 140, 240, 340, 740 constructions described herein may include such a return flange if desired.

Additionally, any of the cart assemblies discussed herein may include a radio frequency identification (“RFID”) tag or other device that can be used to identify the assembly or track information related to its location, contents or activity schedule. FIG. 16, for example, includes an RFID attachment feature 90 located under the angled rim 62 of the container 20 as described with respect to FIGS. 1-3.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A cart comprising:
an upper container defining a limited volume;
a base coupled to said upper container; and
a first wheel assembly attached to said base;
wherein said base and said upper container are separable and said base raises a height of said upper container.

2. The cart of claim 1 further comprising snap fit elements coupling said upper container to said base.

3. The cart of claim 2 wherein the snap fit elements are corresponding protrusions and notches.

4. The cart of claim 3 wherein the corresponding protrusions and notches are ramps and square notches.

5. The cart of claim 3 wherein the corresponding protrusions and notches are a pair of corresponding ridges.

6. The cart of claim 1 further comprising an attachment feature coupling said upper container to said base, wherein said attachment feature is one of a screw, a rivet, a barbed clip, a bird-beak clip, and a Christmas tree fastener.

7. The cart of claim 1 further comprising:
a lid attached to said upper container by at least one hinge and at least one hinge pin; and
a rim at an upper end of said upper container, the rim having an integral first handle and an integral hinge pin attachment adapted to receive said at least one hinge pin.

8. The cart of claim 7 further comprising a RFID tag under said rim.

9. The cart of claim 7 wherein said rim is horizontal.

10. The cart of claim 1, further comprising an axel support on a lower end of said upper container.

11. The cart of claim 10, further comprising:
a second wheel assembly affixed to said upper container; and
a second handle affixed to said base,
wherein said upper cart is rollable when separated from said base or said base is a utility cart when separated from said upper container.

12. A cart assembly comprising:
an upper container;
a base coupled to said upper container; and
a first wheel assembly attached to said base;
wherein said base and said upper container are separable and configurable into more than one cart type.

13. The assembly of claim 12 wherein one of said cart types is a limited volume cart having said upper container raised to a height by said base.

14. The assembly of claim 12 further comprising:
a second wheel assembly attached to a lower end of said upper container when separated from said base; and
a handle integral to said upper container,
wherein one of said cart types is a limited volume cart.

15. The assembly of claim 12 further comprising:
a handled coupled to said base when said base is separated from said upper container,
wherein one of said cart types is a utility cart.

16. The assembly of 12 further comprising snap fit elements coupling said upper container to said base.

17. The assembly of claim 12 further comprising an attachment feature coupling said upper container to said base, wherein said attachment feature is one of a screw, a rivet, a barbed clip, a bird-beak clip, and a Christmas tree fastener.

18. The assembly of claim 12 further comprising:
a lid attached to said upper container by at least one hinge and at least one hinge pin; and
a rim at an upper end of said upper container, the rim having an integral first handle and an integral hinge pin attachment for receiving said at least one hinge pin.

19. The assembly of claim 18 further comprising a RFID tag under said rim.

20. The assembly of claim 18 wherein said rim is horizontal.
